(19) United States
(12) Patent Application Publication
(10) Pub. No.: US 2007/0011884 A1
(43) Pub. Date: Jan. 18, 2007

(54) Switchover mechanism for a reversible control valve of a pneumatic tool

(75) Inventors: Chiang Hua, Taichung City (TW); Ming-Chuan Lin, Taichung City (TW)

Correspondence Address: EGBERT LAW OFFICES, 412 MAIN STREET, 7TH FLOOR, HOUSTON, TX, 77002, US

(73) Assignee: BASSO INDUSTRY CORP., Taichung City (TW)

(21) Appl. No.: 11/327,749

(22) Filed: Jan. 9, 2006

(30) Foreign Application Priority Data
Jun. 29, 2005 (TW) 094121916

(51) Int. Cl. B26B 7/00

(52) U.S. Cl. 30/276

(57) ABSTRACT

The switch mechanism for the reversible control valve of the pneumatic tool focuses on the switchover bar because of the users' right handed and left-handed issues. The primary feature is to make the switchover bar of the reversible control valve and the speed-adjusting valve to roll in the axial direction, and use the combination of the elastic component to make the combination and position section of the connecting section to position with the valve bar positioning section of the reversible control valve. When force of the connecting section of the switchover bar is pulled toward external trigger, it can release the combination and position section and the toggle switch of the switchover bar can achieve switching. When the toggle switch is adjusted, the repositioning may be restored by using the combination and position section and valve bar positioning section without having to take the parts apart.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a pneumatic tool, and more particularly to a device that has a switchover mechanism for a reversible control valve.

### BACKGROUND OF THE INVENTION

Because a common pneumatic tool, such as a pneumatic handle, has a difference between tightening the screws and loosening the screws when in use, the tool reacts to the direction the pneumatic tool turns, which is tightening when turning clockwise, and loosening when turning counterclockwise. Because it must have these two functions, the structure of the pneumatic tool must have a switch design that has reversible control, and usually this is achieved by placing a reversible control. Moreover, a switchover control must be placed on the outside of the pneumatic tool and connected to the reversible control valve mentioned above for users to operate.

The present invention attempts to solve the above-mentioned problems. First, the most common structure for the switchover control is to design the switchover control like a bar, and the bar coordinates with the position of the fingers when holding the pneumatic tool, so that it protrudes and leans toward the left side of the handle of the pneumatic tool. By so doing, the user may use the thumb of the right hand to control it while holding it with the right hand. Even though there are more right handed users in the society, the convenience for left-handed users must be considered. For this reason, when the manufacturers produce the product, they must assemble some models for the left-handed users, even though the user only needs to “switch” the bar for the switchover control to the right side of the hand of the pneumatic tool for the left-handed users to operation. Because the switch mechanism for the reversible control valve of today's pneumatic tool has not considered the need mentioned above, it still has the existing “switching” difficulty. The analysis for this point is described as follows.

Besides the connection of the switchover control, the reversible control valve of the conventional pneumatic tool is usually connected with the speed-adjusting valve, a trigger, that controls the opening and closing of the air way, and the trigger bar. When the reversible control valve is assembled into the slot preset on the handle of the pneumatic tool, it is fixed by a bolt, and this positioning made other parts, such as the switchover control, speed-adjusting valve and trigger bar, that are connected to it, become fixed. Therefore, when the switchover control needs to be adjusted to the relative angle due to the demand of “switching” mentioned above, because it is connected to other components, it cannot be achieved. It must first take the bolt off, and the positions of the parts are released to be able to adjust the switchover control to another relative angle to achieve the purpose of switching. Thus, this conventional structure is time consuming for switching the switchover control, and for the user that does not have the assisting tool, it becomes difficult and inconvenient when the circumstances of right handed and left-handed users occur.

Thus, to overcome the aforementioned problems of the prior art, it would be an advancement if the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

The issue disclosed in the previous section mentioned that the parts of the switchover bar of the reversible control valve of the pneumatic tool must be taken apart completely before it can switch because of the users' right handedness and left-handedness. In comparison, the connecting section 21 of the switchover bar 20 of the present invention can be solved by using the positioning or releasing of the combination of the combination and position section 23 and the valve bar positioning section 14 of the reversible control valve 10, and further using the repositioning function for the elastic component 60 and speed-adjusting valve 30 that coordinate with the outward movement of the switchover bar 20 to make the switching of the toggle switch 22 of the switchover bar 20 easier and faster without having to take the parts apart, and without assisting tools. For the industry and users, it makes the switching more convenient and practical.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of the parts of the pneumatic tool and reversible control valve of the present invention.

FIG. 2 shows an exploded perspective view of the parts of the reversible control valve of the present invention.

FIG. 3 shows a sectional view of the parts of the reversible control valve of the present invention along line A-A of FIG. 4, the toggle switch of the switchover bar being located on the right side of the handle.

FIG. 4 shows a front elevation view of the pneumatic tool in FIG. 3.

FIG. 5 shows an enlarged sectional view of the parts of the reversible control valve in FIG. 3.

FIG. 6 shows a sectional view of the reversible control valve of the present invention along line A-A of FIG. 7, the toggle switch of the switchover bar being adjusted to face down.

FIG. 7 shows a front elevation view of the pneumatic tool in FIG. 6.

FIG. 8 shows a side elevation view of the parts of the reversible control valve of the present invention, the toggle switch of the switchover bar being adjusted to the left side of the handle.

FIG. 9 shows a front elevation view of the pneumatic tool in the FIG. 8.

FIG. 10 shows an exploded perspective view of the structure of speed-adjusting valve of the present invention.

FIG. 11 shows a sectional view of the structure of the speed-adjusting valve of the present invention.

FIG. 12 shows an exploded perspective view of the structure of the reversible control valve of another embodiment of the present invention.

FIG. 13 shows a sectional view of the structure of the reversible control valve of another embodiment of the present invention.

FIG. 14 shows a sectional view of the structure of the reversible control valve of another embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

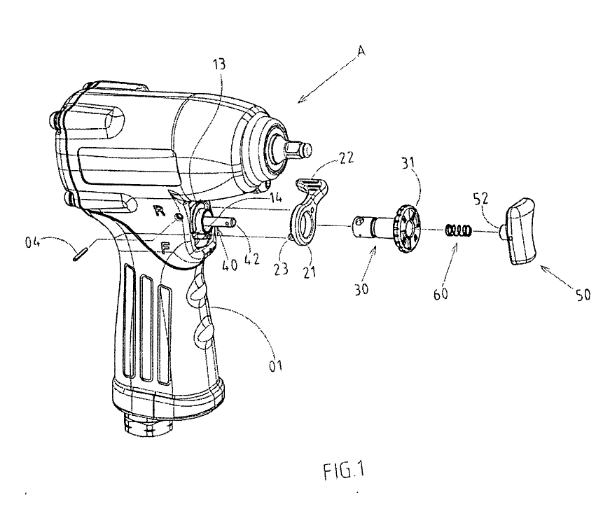

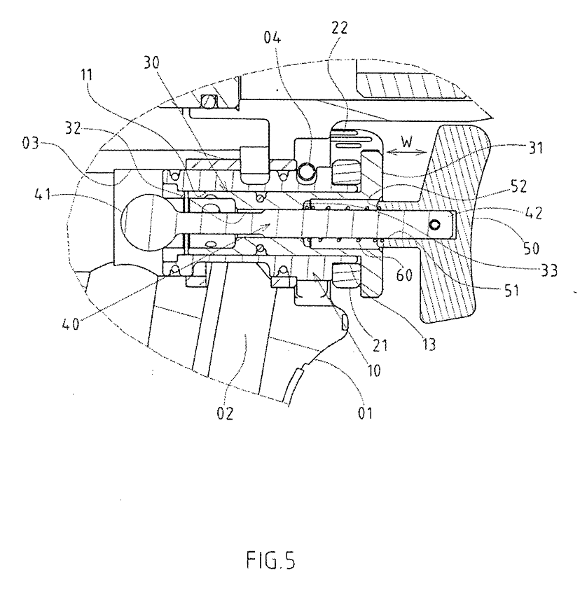

As shown in FIGS. 1-4, a switchover mechanism for the reversible control valve of a pneumatic tool, in which a pneumatic tool (A) is a pneumatic handle. The purpose for the reversible control valve is to be able to reverse the switch for the switchover bar without having to take of the reversible control valve, so that it can quickly be change to left-handed mode or right handed mode.

The invention includes a reversible control valve 10, which is a hollow cylinder that has a through slit 11 in the center, and it is placed in the horizontal slot 01 (as shown in FIG. 5) on the air inlet channel 02 of the handle 01 of the pneumatic tool A. However, the direction of its axle is positioned by using a bolt 04 bolted horizontally to the handle 01, and the inner wall of the reversible control valve 10 has an air hole 12. The external end of the reversible control valve 10 has a protruding tube 13 sticking out to the external side of the handle. A valve bar positioning section 14 is placed on the external side of the reversible control valve 10, and the valve bar positioning section 14 of the present embodiment is shaped as concave slots on both sides of the protruding tube 13.

There is a switchover bar 20, which includes a connecting section 21 and a toggle switch 22, and the connecting section 21 of the present embodiment is a round cylinder that can be connected to the protruding tube 13 of the external end of the reversible control valve 10. The inside of the connecting section 21 has a combination and position section 23 that can be positioned with the valve bar positioning section 14 that is on the outside of the reversible control valve 10. The combination and position section 23 of the present embodiment is placed on the two sides of the connecting section 21 and become protruding blocks that are 180° apart, which can be positioned with the valve bar positioning section 14 mentioned above. Moreover, the toggle switch 22 of the switchover bar 20 is facing one side of the handle 01 (right side or left side) extended, and the toggle switch is shaped for the user's hands, being an expanded plate in the present embodiment. In so doing, when switching the toggle switch 22, it can turn with the reversible control valve 10 by the combination of the combination and position section 23 mentioned above, and the valve bar positioning section 14, and further change the relative angle of the air flow channel 02 made by the air hole 12 and pneumatic tool A to achieve the reversible control for the pneumatic tool.

A speed-adjusting valve 30, which has a hollow cylinder shape, is placed in the through slit 11 of the reversible control valve 10, and makes it turn and roll in the axial direction. On the external side, the speed-adjusting valve 30 has a control wheel 31 that has an expanded outer diameter, and the control wheel is placed on the outside of the connecting section 21 of the switchover bar to keep the speed-adjusting valve from rolling inward and create limiting function. It also keeps the switchover bar 20 from moving outward and creates a limiting function. A through hole 32 is placed in the center of the speed-adjusting valve 30, and the outside of the through hole has a section of an expanded diameter that shapes a shoulder 33.

There is a trigger bar 40, which is a bar shape, and its stick rolls through the through hole 32 of the speed-adjusting valve 30. A limit block 41 is placed inside the trigger bar 40 (an expanded ball shape in the present embodiment) to block the inside of the through slit 11 of the reversible control valve 10, so that the trigger bar 40 can not continue to roll out. The external side of the trigger bar 40 protrudes out from the outside of the handle as long as the length of the through hole 32 of the speed-adjusting valve 30 to shape a trigger connector 42.

A trigger 50 is made with a button like body, and its inside has a sleeving hole 51 for connecting to the trigger connector 42 on the external end of the trigger bar 40 for a human hand to open the air pressure channel. A distance W (as shown FIG. 5) is placed between the trigger 50 and the control wheel of the speed-adjusting valve 30.

An elastic component 60 in the present embodiment is a spiral spring, which is placed between the shoulder 33 of the through hole 32 of the speed-adjusting valve 30 and the internal surface 52 of the trigger 50. It pushes the trigger 50 outward and pushes the speed-adjusting valve 30 inward so that the control wheel 31 of the speed-adjusting valve 30 pushes against the connecting section 21 of the switchover bar 20. The combination and position section 23 inside the connecting section 21 can be positioned with the valve bar positioning section 14 of the reversible control valve 10.

Through the above structure and design, the operation of the reversible control valve of the pneumatic tool disclosed by the present is explained as follows.

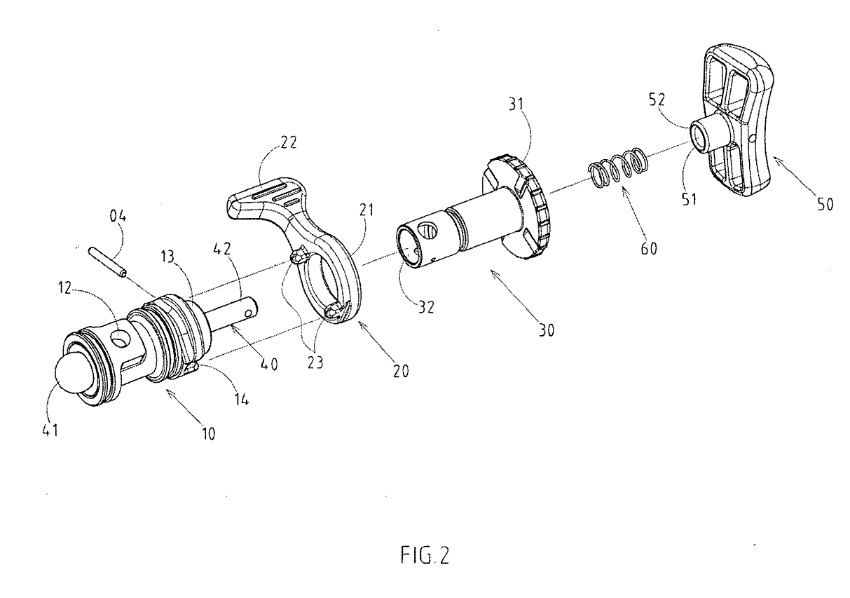

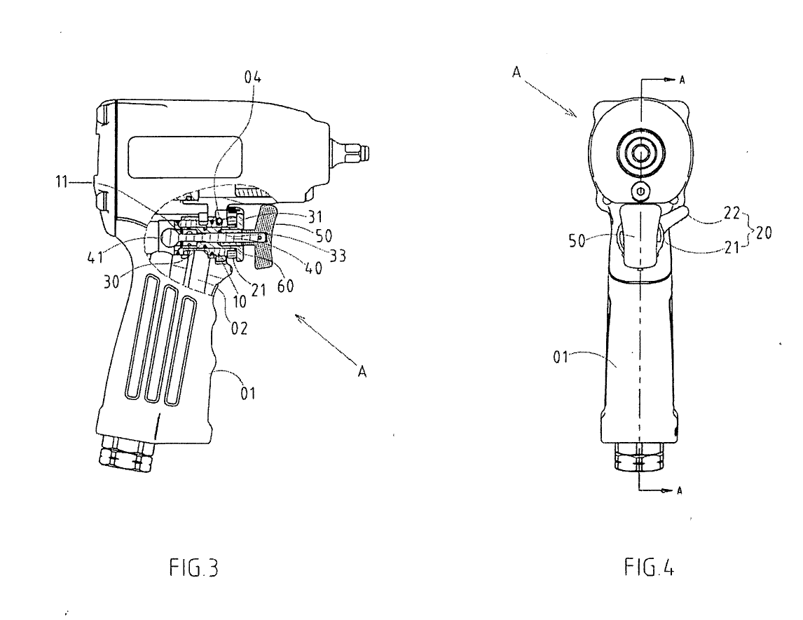

As shown in FIGS. 3, 4, 5, the toggle switch 22 of the switchover bar 20 are located in the right side of the handle 01 (as shown in the figures), and these figures show a structure that is used by right handed users. As shown in FIG. 5, pushing by the elastic component 60, the inside of the control wheel 31 of the speed-adjusting valve 30 may be pushed against the outside of the connecting section 21 of the switchover bar 20, and the combination and position section 22 inside the connecting section 21 may be maintained by connecting with the valve bar positioning section 14 of the reversible control valve 10 (as shown in FIG. 2).

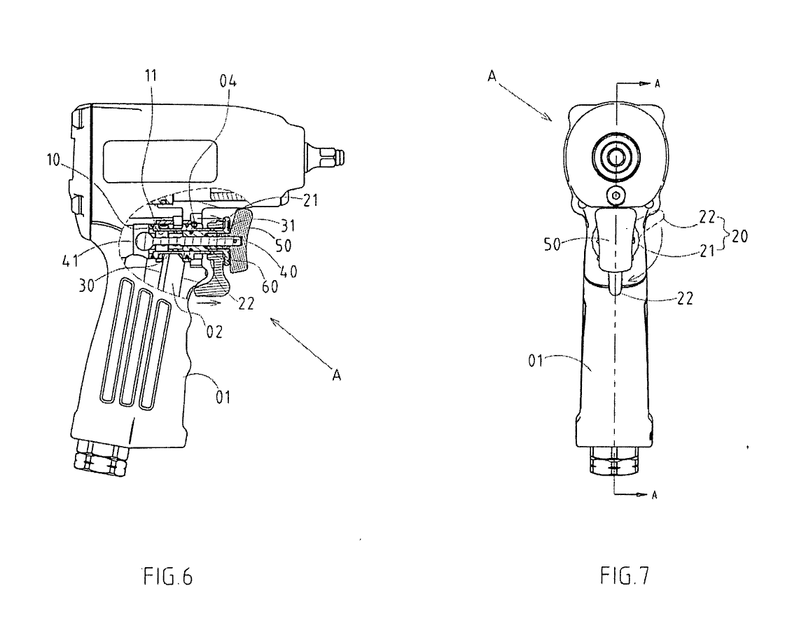

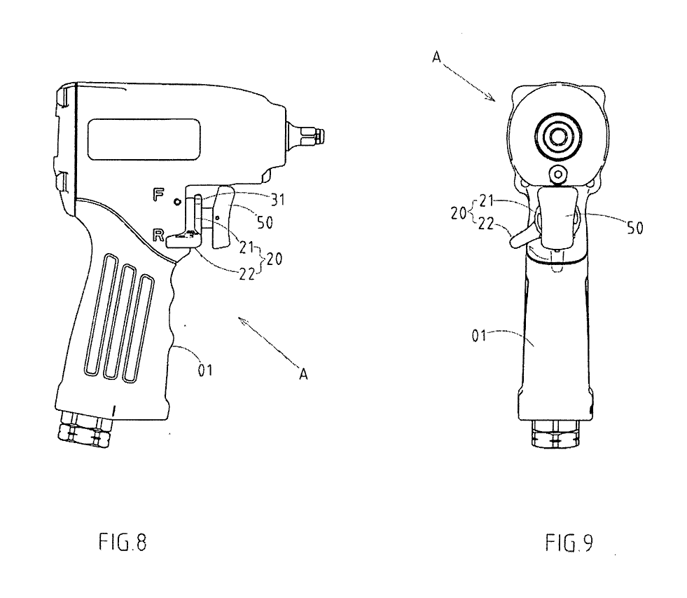

As shown in FIG. 6, when the structure needs to be switched to the structure for left-handed users, the users may pull the switch bar 20 toward external trigger 50. Because there is a distance W between the trigger and the control wheel of the speed-adjusting valve 30, it is achieved by this action. When the switchover bar 20 is pulled out to a preset distance, the combination and position section 23 inside its connecting section 21 can be released from the valve bar positioning section 14 of the reversible control valve 10, and the elastic component 60 is pressed and restored with its elasticity. As shown in FIGS. 7 and 9, the toggle switch 22 of the switchover bar 20 can be adjusted to the left side (as shown in the figures) of the handle 01 and can be switched to the structure for the left-handed users. At this time, the pulling force of the switchover bar 20 may be released, because at this angle, the combination and position section 23 and the valve bar positioning section 14 is facing each other. When the switchover bar 20 uses the restoring elastic of the elastic component 60 to reposition inward, the position may be restored through the coordination from both parts.

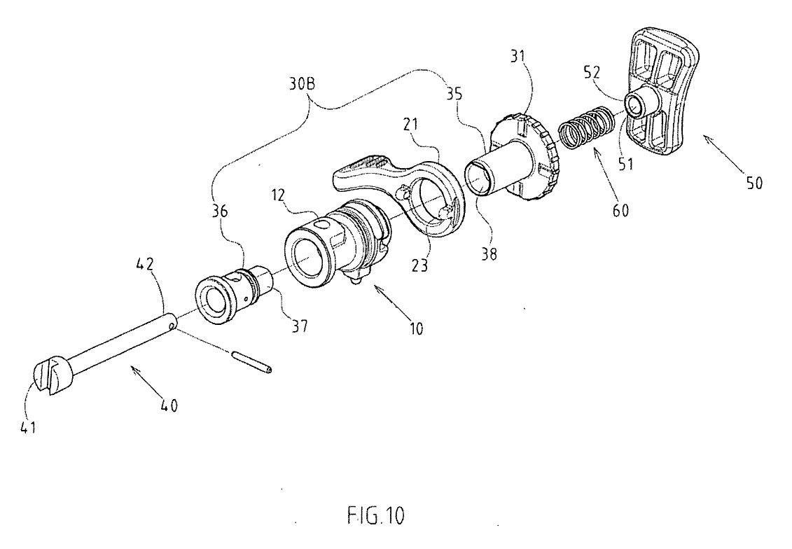

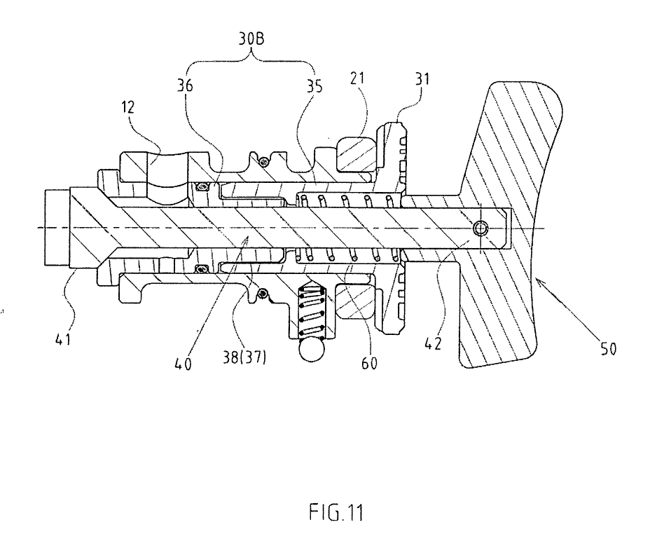

As shown in FIGS. 10, 11, the speed-adjusting valve 30B mentioned above can also be the structure made of two sections, which means, it can be made by a front valve 35 and a back valve 30B of the speed-adjusting valve 30B. Among them, the space between the back valve 36 and the front valve 35 may be positioned by the connection of the protruding tube 37 and the insert slot 38. By the combination of these two sections, it can assemble another preferred model for speed-adjusting valve 30B.

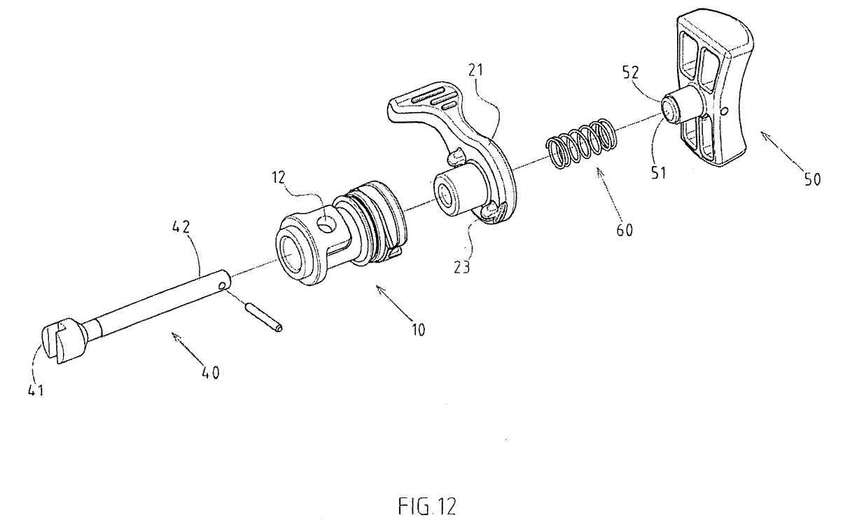

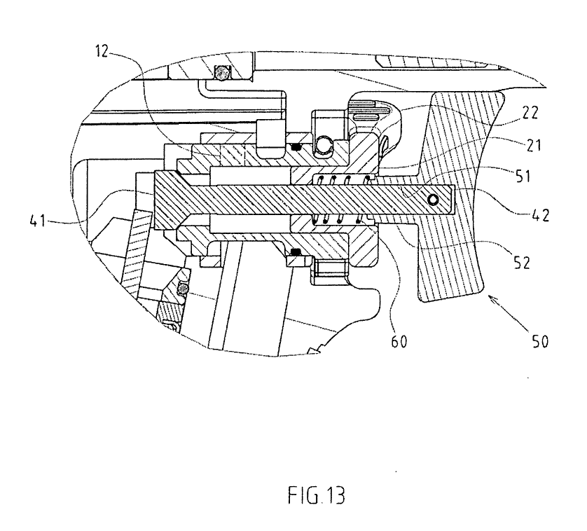

As shown in FIGS. 12 and 13, the structure of the reversible control valve of the present invention can also be the speed-adjusting valve 30. By so doing, its combination is shown in FIG. 13, its connecting section 21 of the switchover bar 20 being placed against the reversible control valve 10. It can achieve the limiting position by the pushing the sleeving hole 51 against the elastic component 60.

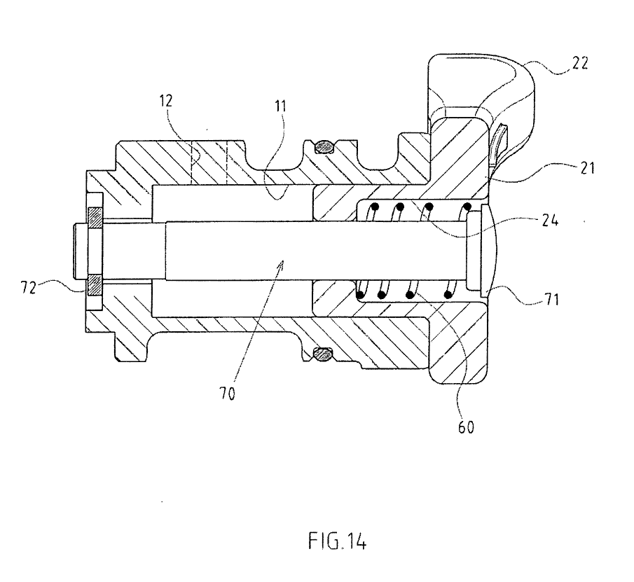

As shown in FIG. 14, the structure of reversible control valve disclosed in the present invention can be the structural space of speed-adjusting valve 30 and the trigger 50, which means, the position for the reversible control valve is not limited to the structure that has the same position as the trigger. A through slit 11 is placed in the center of the reversible control valve 30, and it has an air hole 12 inside. The switchover bar 20, which includes a connecting section 21 and a toggle switch 22, and the connecting section 21 are placed on the external end of the reversible control valve 30. The connecting section has combination and position section that can be positioned with the valve bar positioning section on the external end of the reversible control valve 30 (which is the same as the 23 and 14 in FIG. 2). The toggle switch 22 is extended toward one side. The elastic component 60 is placed in the preset area of the switchover bar 20 (in this embodiment, structure of an expanding groove 24 is placed on the external end of the switchover bar), and by so doing to make the switchover restore its position.

The switchover bar 20 of the present embodiment can be limited and by not coming off a positioning shaft 70, such as by an expanding edge 71 formed on the external end of the positioning shaft 70 of the present embodiment to block the external end of the elastic component 60. A buckle 72 or bolt may be used inside the positioning shaft 70 to block the inside of the reversible control valve 30 so that the positioning shaft 70 is positioned. By this design, when the force of the switchover bar 20 is placed on the elastic component 60 (the switchover bar is pulled outward in this embodiment), it breaks the combination and position section of the switchover bar 20 away from the valve bar positioning section of the reversible control valve 30. When turning the switchover bar 20 to preset area, the elastic component 60 may be repositioned and makes the combination and position section of the switchover bar 20 be positioned with the valve bar positioning section of the reversible control valve 30.

We claim:

1. A switchover mechanism for a reversible control valve of a pneumatic tool, said mechanism comprising:
a reversible control valve, being placed on an air inlet channel of the pneumatic tool and being turnable, a direction of an axle thereof being positioned, a through slit being placed in a center of the reversible control valve, an air hole being placed inside the reversible control valve, a protruding tube being placed on an external side of a handle, and a valve bar positioning section being placed on the external side;
a switchover bar, having a connecting section and toggle switch, said connecting section being placed on an outside of the reversible control valve, and having a combination and position section that can be positioned with the valve bar positioning section on the external end of the reversible control valve, the toggle switch being extended toward one side thereof;
a trigger bar, having stick rolls through the through slit of the reversible control valve, a limit block being placed inside the trigger bar to block an inside of the reversible control valve, said trigger bar not being able to continue to roll outward, the external side of the trigger bar protruding outward to shape a trigger connector;
a trigger, connected to the trigger bar; and
an elastic component, placed in an area preset on the switchover bar to make the switchover bar re-position.

2. The mechanism defined in claim 1, wherein the valve bar positioning section of the reversible control valve and the combination and position section of the switchover bar is comprised of a combination of concave slot and protruding block.

3. The mechanism defined in claim 1, further comprising:
a speed-adjusting valve added in the through slit of the reversible control valve, turning and rolling in an axial direction, a control wheel on an external end of the speed-adjusting valve being pushed against the external side of the connecting section of the switchover bar, and limiting the speed-adjusting valve and switchover bar.

4. A switchover mechanism for a reversible control valve of a pneumatic tool, said switchover mechanism comprising:
a reversible control valve, being formed of a hollow cylinder that has a through slit in the center, and placed in a horizontal slot on the air inlet channel of the handle of the pneumatic tool, a direction of an axle thereof being positioned by using a bolt bolted horizontally to the handle, an inner wall of the reversible control valve having an air hole, an external end of the reversible control valve having a protruding tube sticking out to the external side of the handle, a valve bar positioning section being placed on the external side of the reversible control valve;
a switchover bar, having a connecting section and a toggle switch, the connecting section being a round cylinder that can be connected to the protruding tube of the external end of the reversible control valve, he inside of the connecting section having a combination and position section that can be positioned with the valve bar positioning section that is on the outside of the reversible control valve, the toggle switch of the switchover bar facing one side of the handle extended and, in so doing, when switching the toggle switch, the toggle switch being turnable with the reversible control valve by the combination of the connecting section, a relative angle of an air flow channel formed by an air hole and pneumatic tool being changeable to achieve the reversible control for the pneumatic tool;
a speed-adjusting valve, having a hollow cylinder shape, being placed in the through slit of the reversible control valve like center of the axle, turning and rolling in the axial direction, having, on the external side of the speed-adjusting valve, a control wheel that has the expanded outer diameter, the control wheel being placed on the outside of the connecting section of the switchover bar to keep the speed-adjusting valve from rolling inward and create a limiting function for said switch bar, a through hole being placed in the center of the speed-adjusting valve, the outside of the through hole having a section of an expanded diameter that shapes a shoulder;
a trigger bar, having a bar shape and stick rolls thereof through the through hole of the speed-adjusting valve, a limit block being placed inside the trigger bar to block the inside of the through slit of the reversible control valve, so that the trigger bar cannot continue to roll outward, the external side of the trigger bar protruding out from the outside of the handle as long as the length of the through hole of the speed-adjusting valve to shape a trigger connector;
a trigger, being formed with a button like body and an inside connected to the trigger connector on the external end of the trigger bar, a distance being placed between the trigger and the control wheel of the speed-adjusting valve; and
an elastic component, placed between a shoulder of the through hole of the speed-adjusting valve and the internal surface of the trigger and being in pushing engagement with said trigger outward and the speed-adjusting valve inward so that the control wheel of the speed-adjusting valve pushes against the connecting section of the switchover bar, the combination and position section inside the connecting section being positioned with the valve bar positioning section of the reversible control valve when the force of the connecting section of the switchover bar is pulled toward external trigger, the reversible control valve releasing the combination and position section from the valve bar positioning section, the toggle switch of the switchover bar being adjusted and switching, and, when the toggle switch is adjusted to another angle, the repositioning being restored by using the combination of the combination and position section and valve bar positioning section.

5. The mechanism defined in claim 4, wherein the valve bar positioning section placed on the reversible control valve is comprised of two concave slots placed on the both sides of the protruding tube in 180° angle, the combination and position section of the switchover bar being the protruding blocks placed on both sides of connecting section in 180° angle.

6. The mechanism defined in claim 4, wherein the limit block inside the trigger bar is comprised of an expanded round ball.

7. The mechanism defined in claim 4, wherein the elastic component is comprised of a spiral spring.

8. A switchover mechanism for a reversible control valve of a pneumatic tool, said switchover mechanism comprising:
a reversible control valve, being placed on the air inlet channel of the pneumatic tool and being turnable, a direction of an axle thereof being positioned, a through slit being placed in the center of the reversible control valve, an air hole being placed inside, a protruding tube being placed on the external side of the handle, and a valve bar positioning section being placed on the external side;
a switchover bar, having a connecting section and toggle switch, said connecting section being placed on the outside of the reversible control valve, and having a combination and position section that can be positioned with the valve bar positioning section on the external end of the reversible control valve, the toggle switch being extended toward one side;
a positioning shaft placed in the through slit of the reversible control valve to limit the switchover bar; and
an elastic component placed in the area preset for switchover bar to reposition the switch bar.

9. The mechanism defined in claim 8, wherein the valve bar positioning section of the reversible control valve and the combination and position section of the switchover bar is comprised of a concave slot and protruding block.

10. The mechanism defined in claim 8, further comprising:
a speed-adjusting valve placed in the through slit of the reversible control valve, the speed-adjusting valve being turnable and rollable in an axial direction, a control wheel on the external side of the speed-adjusting valve being pushed against the outside of the connecting section of the switchover bar and limiting the speed-adjusting valve and switchover bar.

11. The mechanism defined in claim 8, further comprising:
an expanding edge formed on the external end of the positioning shaft to block the external end of the elastic component, and
a buckle or bolt inside the positioning shaft to block the inside the reversible control valve and to position the positioning shaft.

12. A switchover mechanism for a reversible control valve of a pneumatic tool, said switchover mechanism comprising:
a reversible control valve, placed on an air inlet channel of the pneumatic tool and being turnable, a direction of an axle thereof being positioned, a through slit being placed in the center of the reversible control valve, an air hole being placed inside, a protruding tube being placed on the external side of the handle, a valve bar positioning section being placed on the external side;
a switchover bar, having a connecting section and toggle switch, said connecting section being placed on the outside of the reversible control valve, and having a combination and position section that can be positioned with the valve bar positioning section on the external end of the reversible control valve, the toggle switch being extended toward one side; and
an elastic component, placed in the area that is preset on the switchover bar to reposition the switchover bar; wherein, when force of the switchover bar is placed on the elastic component, the elastic component breaks the combination and position section of the switchover bar away from the valve bar positioning section of the reversible control valve; and wherein, when turning the switchover bar to preset area, the elastic component may be repositioned, and makes the combination and position section of the switchover bar position with the valve bar positioning section of the reversible control valve.
